(19) United States
(12) Patent Application Publication
(10) Pub. No.: US 2024/0340477 A1
(43) Pub. Date: Oct. 10, 2024

(54) SERVER, METHOD AND COMPUTER PROGRAM

(71) Applicant: 17LIVE Japan Inc., Tokyo (JP)

(72) Inventor: Chu-Chuan LIN, Taipei City (TW)

(21) Appl. No.: 18/366,233

(22) Filed: Aug. 7, 2023

(30) Foreign Application Priority Data
Apr. 6, 2023 (JP) 2023-062272

(51) Int. Cl. H04N 21/24; G06Q 30/015; H04N 21/2187; H04N 21/25; H04N 21/258; H04N 21/4425; H04N 21/4788

(52) U.S. Cl. CPC H04N 21/24; G06Q 30/015; H04N 21/2187; H04N 21/251; H04N 21/25866; H04N 21/4425; H04N 21/4788

(57) ABSTRACT

A server for handling operations in a live streaming platform, comprising: receiving an operation from a user terminal of a user; sending a message to the user terminal of the user in response to detecting an issue from the operation; and determining type of customer service according to information of the operation and the issue. The present disclosure may provide real-time support to customers and allow issues to be resolved in a quick and efficient manner. Moreover, the number of customer complaints may be reduced and overall customer satisfaction may be improved. Therefore, the user experience may be improved.

### CROSS-REFERENCE TO RELATED APPLICATIONS

This application is based on and claims the benefit of priority from Japanese Patent Application Serial No. 2023-062272 (filed on Apr. 6, 2023), the contents of which is hereby incorporated by reference in its entirety.

### TECHNICAL FIELD

This disclosure relates to information and communication technology, and in particular, to a server, method and computer program in a live streaming service.

### BACKGROUND

Some APPs or platforms provide live streaming service for streamers and viewers to interact with each other. Streamers can perform to entertain and engage viewers and the viewers may send messages or gifts to support the streamers.

In the live streaming platform, if the users encounter problems, what they could do is to figure it out by themselves or report to the customer service for help. Patent Document 1 discloses a method for troubleshooting. In Patent Document 1, the error log is inputted into a troubleshooting model to obtain an analysis result.

However, the current customer service still takes time and effort to identify problems and troubleshoot. Therefore, there is a need for customer service that can accurately detect problems encountered by the user and provide effective assistance to the user in solving the problem.
[Patent Document 1]: CN115357497A

### SUMMARY

An embodiment of subject application relates to a server for handling operations in a live streaming platform, comprising: receiving an operation from a user terminal of a user; sending a message to the user terminal of the user in response to detecting an issue from the operation; and determining type of customer service according to information of the operation and the issue.

Another embodiment of subject application relates to a method for handling operations in a live streaming platform, comprising: receiving an operation from a user terminal of a user; sending a message to the user terminal of the user in response to detecting an issue from the operation; and determining type of customer service according to information of the operation and the issue.

Another embodiment of subject application relates to a computer program for causing a server to realize the functions of: receiving an operation from a user terminal of a user; sending a message to the user terminal of the user in response to detecting an issue from the operation; and determining type of customer service according to information of the operation and the issue.

The present disclosure may provide real-time support to customers and allow issues to be resolved in a quick and efficient manner. Moreover, the number of customer complaints may be reduced and overall customer satisfaction may be improved. Therefore, the user experience may be improved.

### BRIEF DESCRIPTION OF THE DRAWINGS

FIG. 1 is a schematic configuration of a live streaming system 1 according to some embodiments of subject application;

FIG. 2 is a schematic block diagram of the user terminal 20 according to some embodiments of subject application;

FIG. 3 is a schematic block diagram of the server 10 according to some embodiments of subject application;

FIG. 4 shows an exemplary data structure of the stream DB 320 of FIG. 3;

FIG. 5 shows an exemplary data structure of the user DB 322 of FIG. 3;

FIG. 6 shows an exemplary data structure of the log DB 324 of FIG. 3;

FIG. 7 shows an exemplary data structure of the language model 326 of FIG. 3;

FIG. 8 shows an exemplary data structure of the look-up table 330 of FIG. 3;

FIG. 9-FIG. 12 are exemplary functional configurations of the live streaming system 1 according to some embodiments of subject application;

FIG. 13-FIG. 14 are exemplary screen images of a live streaming setting screen 600 shown on the display of the streamer user terminal 20;

FIG. 15-FIG. 17 are flowcharts showing steps of an application activation process on live streaming system 1 according to some embodiments of subject application;

FIG. 18 is exemplary functional configuration of the live streaming system 1 according to some embodiments of subject application;

FIG. 19 is an exemplary sequence chart illustrating an operation of the configuration of the live streaming system 1 according to some embodiments of subject application;

FIG. 20 is an exemplary hardware configuration of the information processing device according to some embodiments of subject application.

### DETAILED DESCRIPTION

Hereinafter, the identical or similar components, members, procedures or signals shown in each drawing are referred to with like numerals in all the drawings, and thereby an overlapping description is appropriately omitted. Additionally, a portion of a member which is not important in the explanation of each drawing is omitted.

The live streaming system 1 according to some embodiments of subject application provides enhancement among the users to communicate and interact smoothly. More specifically, it entertains the viewers and streamers in a technical way.

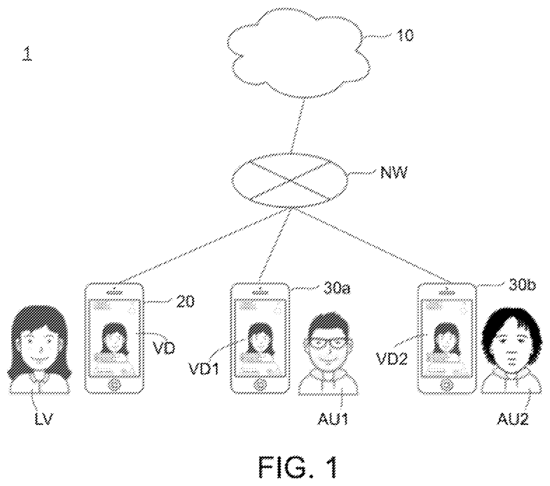

FIG. 1 shows a schematic configuration of a live streaming system 1 according to some embodiments of subject application. The live streaming system 1 provides a live streaming service for the streaming streamer (may also be referred as live or streamer) LV and viewer (may also be referred as audience) AU (AU1, AU2 . . . ) to interact mutually in real time. As shown in FIG. 1, the live streaming system 1 may include a server 10, a user terminal 20 and a user terminal 30 (30a, 30b . . . ). The user terminal 20 may be a streamer and the user terminal 30 may be a viewer. In some embodiments, the streamers and viewers may be referred to as the user. The server 10 may include one or a plurality of information processing devices connected via network NW. The user terminal 20 and 30 may be, for example, a portable terminal such as the smartphone, tablet, laptop PC, recorder, mobile game console, wearable device or the like, or the stationary computer such as desktop PC. The server 10, user terminal 20 and user terminal 30 may be communicably connected by any type of wire or wireless network NW.

The live streaming system 1 is involved in the streamer LV, the viewer AU, and APP provider (not shown), who provides the server 10. The streamer LV may record his/her own contents such as songs, talks, performance, game streaming or the like by his/her own user terminal 20 and upload to the server 10 and be the one who distributes contents in real time. In some embodiments, the streamer LV may interact with the viewer AU via the live streaming.

The APP provider may provide a platform for the contents to go on live streaming in the server 10. In some embodiments, the APP provider may be the media or manager to manage the real time communication between the streamer LV and viewer AU. The viewer AU may access the platform by the user terminal 30 to select and watch the contents he/she would like to watch. The viewer AU may perform operations to interact with the streamer, such as commenting or cheering the streamer, by the user terminal 30. The streamer, who provides the contents, may respond to the comment or cheer. The response of the streamer may be transmitted to the viewer AU by video and/or audio or the like. Therefore, a mutual communication among the streamer and viewer may be accomplished.

The “live streaming” in this specification may be referred to as the data transmission which enables the contents the streamer LV recorded by the user terminal 20 to be substantially reproduced and watched by the viewer AU via the user terminal 30, In some embodiments, the “live streaming” may also refer to the streaming which is accomplished by the above data transmission. The live streaming may be accomplished by the well-known live streaming technology such as HTTP Live Streaming, Common Media Application Format, Web Real-Time Communications, Real-Time Messaging Protocol, MPEG DASH or the like. The live streaming may further include the embodiment that the viewer AU may reproduce or watch the contents with specific delay while the streamer is recording the contents. Regarding the magnitude of the delay, it should be at least small enough to enable the streamer LV and the viewer AU to communicate. However, live streaming is different from so-called on-demand streaming. More specifically, the on-demand streaming may be referred to as storing all data, which records the contents, in the server and then providing the data from the server to the user at random timing according to the user's request.

The “streaming data” in this specification may be referred to as the data includes image data or voice data. More specifically, the image data (may be referred to as video data) may be generated by the image pickup feature of the user terminal 20 and 30. The voice data (may be referred to as audio data) may be generated by the audio input feature of the user terminal 20 and 30. The streaming data may be reproduced by the user terminal 20 30, so that the contents relating to users may be available for watching. In some embodiments, during the period from the streaming data being generated by the user terminal of the streamer to being reproduced by the user terminal of the viewer, the processing of changing format, size or specification of the data, such as compression, extension, encoding, decoding, transcoding or the like, is predictable. Before and after this kind of processing, the contents (such as video and audio) are substantially unchanged, so it is described in the current embodiments of the present disclosure that the streaming data before being processed is the same as that after being processed. In other words, if the streaming data is generated by the user terminal of the streamer and reproduced by the user terminal of the viewer via the server 10, the streaming data generated by the user terminal of the streamer, the streaming data passed through the server 10 and the streaming data received and reproduced by the by the user terminal of the viewer are all the same streaming data.

As shown in FIG. 1, the streamer LV is providing the live streaming. The user terminal 20 of the streamer generates the streaming data by recording his/her video and/or audio, and transmits to the server 10 via the network NW. At the same time, the user terminal 20 may display the video VD on the display of the user terminal 20 to check the streaming contents of the streamer LV.

The viewer AU1, AU2 of the user terminal 30a, 30b, who request the platform to provide the live streaming of the streamer, may receive streaming data corresponding to the live streaming via the network NW and reproduce the received streaming data to display the video VD1, VD2 on the display and output the audio from a speaker or the like. The video VD1, VD2 displayed on the user terminal 30a, 30b respectively may be substantially the same as the video VD recorded by the user terminal of the streamer LV, and the audio outputted from the terminal 30a, 30b may also be substantially the same as the audio recorded by the user terminal of the streamer LV.

The recording at the user terminal 20 of the streamer may be simultaneous with the reproducing of the streaming data at the user terminal 30a, 30b of the viewer AU1, AU2. If a viewer AU1 inputs a comment on the contents of the streamer LV into the user terminal 30a, the server 10 will display the comment on the user terminal 20 of the streamer in real time, and also display on the user terminal 30a, 30b of the viewer AU1, AU2 respectively. If the streamer LV responds to the comment, the response may be outputted as the text, image, video or audio from the terminal 30a, 30b of the viewer AU1, AU2, so that the communication of the streamer LV and viewer LV may be realized. Therefore, the live streaming system may realize the live streaming of two-way communication.

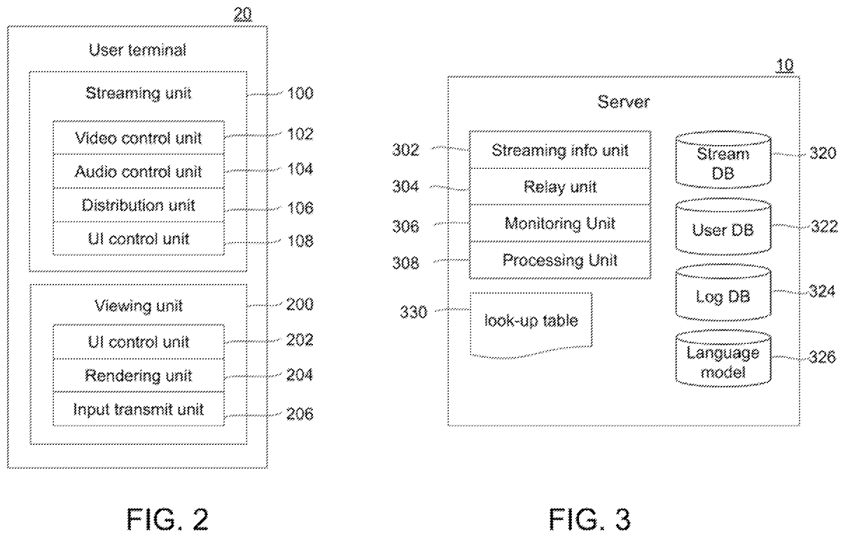

FIG. 2 is a block diagram showing a function and configuration of the user terminal 20 in FIG. 1 according to the embodiment of the present disclosure. The user terminal 30 has the similar function and configuration of the user terminal 20. The blocks depicted in the block diagram of this specification are implemented in hardware such as devices like a CPU of a computer or mechanical components, and in software such as a computer program depicts functional blocks implemented by the cooperation of these elements. Therefore, it will be understood by those skilled in the art that the functional blocks may be implemented in a variety of manners by a combination of hardware and software.

The streamer LV and viewer AU may download and install the live streaming application (live streaming APP) of the present disclosure to the user terminal 20 and 30 from the download site via network NW. Or the live streaming APP may be pre-installed in the user terminal 20 and 30. By the execution of the live streaming by the user terminal 20 and 30, the user terminals 20 and 30 may communicate with the server 10 via the network NW to realize a plurality of functions. The functions realized by the execution of the live streaming APP by the user terminal 20 and 30 (More specifically, the processor such as CPU) is described below as the functions of the user terminal 20 and 30. These functions are basically the functions that the live streaming APP makes the user terminals 20 and 30 realize. In some embodiments, these functions may also be realized by transmitting from the server 10 to the web browser of the user terminal 20 and 30 via network NW and be executed by the computer program of the web browser. The computer program may be written in the programming language such as HTML (Hyper Text Markup Language) or the like.

The user terminal 20 includes streaming unit 100 and viewing unit 200. In some embodiments, the streaming unit 100 is configured to record the audio and/or video data of the user and generate streaming data to transmit to the server 10. The viewing unit 200 is configured to receive and reproduce streaming data from server 10. In some embodiments, a user may activate the streaming unit 100 when broadcasting or activate the viewing unit 200 when watching streaming respectively. In some embodiments, the user terminal who is activating the streaming unit 100 may be referred to as an streamer or be referred to as the user terminal which generates the streaming data. The user terminal who is activating the viewing unit 200 may be referred to as an viewer or be referred to as the user terminal which reproduces the streaming data.

The streaming unit 100 may include video control unit 102, audio control unit 104, distribution unit 106 and UI control unit 108. The video control unit 102 may be connected to a camera (not shown) and the video is controlled by the camera. The video control unit 102 may obtain the video data from the camera. The audio control unit 104 may be connected to a microphone (not shown) and the audio is controlled by the microphone. The audio control unit 104 may obtain the audio data from the microphone.

The distribution unit 106 receives streaming data, which includes video data from the video control unit 102 and audio data from the audio control unit 104, and transmits to the server 10 via network NW. In some embodiments, the distribution unit 106 transmits the streaming data in real-time. In other words, the generation of the streaming data from the video control unit 102 and audio control unit 104, and the distribution of the distribution unit 106 is performed simultaneously.

UI control unit 108 controls the UI for the streamer. The UI control unit 108 is connected to a display (not shown) and is configured to generate the streaming data to whom the distribution unit 106 transmits, reproduces and displays the streaming data on the display. The UI control unit 108 shows the object for operating or the object for instruction-receiving on the display and is configured to receive the tap input from the streamer.

The viewing unit 200 may include UI control unit 202, rendering unit 204, input transmit unit 206. The viewing unit 200 is configured to receive streaming data from server 10 via network NW. The UI control unit 202 controls the UI for the viewer. The UI control unit 202 is connected to a display (not shown) and/or speaker (not shown) and is configured to display the video on the display and output the audio from the speaker by reproducing the streaming data. In some embodiments, Outputting the video on the display and audio from the speaker may be referred to as “reproducing the streaming data”. The UI control unit 202 may be connected to an input unit such as touch panel, keyboard or display or the like to obtain input from the users.

The rendering unit 204 may be configured to render the streaming data from the server 10 and the frame image. The frame image may include user interface objects for receiving input from the user, the comments inputted by the viewers and the data received from the server 10. The input transmit unit 206 is configured to receive the user input from the UI control unit 202 and transmit to the server 10 via the network NW.

In some embodiments, the user input may be clicking an object on the screen of the user terminal such as selecting a live stream, entering a comment, sending a gift, following or unfollowing an user, voting in an event, gaming or the like. For example, the input transmit unit 206 may generate gift information and transmit to server 10 via the internet NW if the user terminal of the viewer clicks a gift object on the screen in order to send a gift to the streamer.

In some embodiments, the streamer or viewers may encounter problems in the live streaming platform. For example, the distribution unit 106 may not be able to transmit the video data to the server 10 when the streamer starts the stream, or the rendering unit 204 may not be able to receive video data from the server 10 when the viewer watches the stream. The input transmit unit 206 may not be able to send messages or gifts to the streamer successfully due to some technical issues or the like. In some embodiments, the problems may be an unknown issue. However, some problems may also be encountered by the other users. Therefore, applying for a language model trained by historical or real-time data may effectively solve the problem.

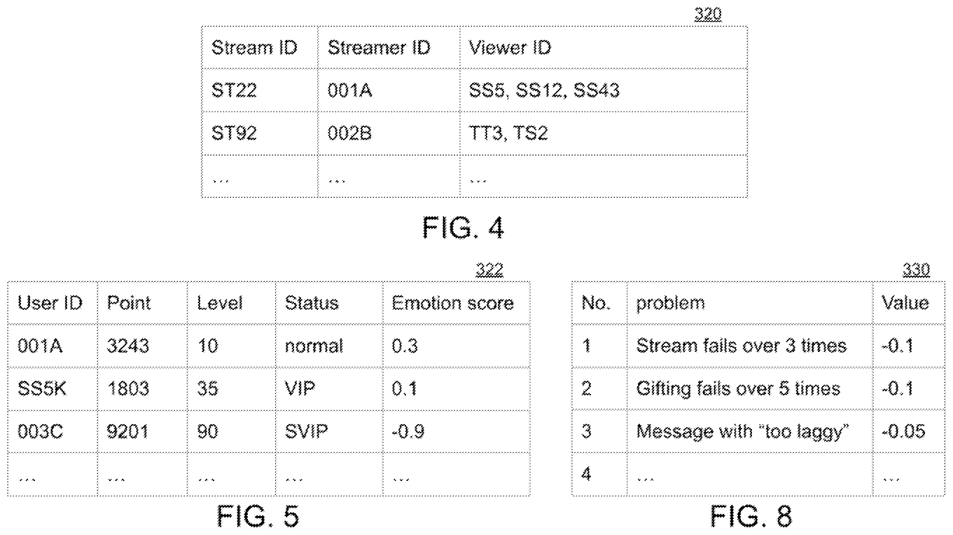

FIG. 3 is a schematic block diagram of the server 10 according to some embodiments of the subject application. The server 10 may include streaming info unit 302, relay unit 304, monitoring unit 306, processing unit 308, stream DB 320, user DB 322, log DB 324, language model 326 and look-up table 330.

The streaming info unit 302 receives the request of live streaming from the user terminal 20 of the streamer via the network NW. Once receiving the request, the streaming info unit 302 registers the information of the live streaming on the stream DB 320. In some embodiments, the information of the live streaming may be the stream ID of the live streaming and/or the streamer ID of the streamer corresponding to the live streaming.

Once receiving the request of providing the information of the live streaming from the viewing unit 200 of the user terminal 30 from the viewer via the network NW, the streaming info unit 302 refers to the stream DB 320 and generates a list of the available live streaming.

The streaming info unit 302 then transmits the list to the user terminal 30 via the network NW. The UI control unit 202 of the user terminal 30 generates a live streaming selection screen according to the list and displays the list on the display of the user terminal 30.

Once the input transmit unit 206 of the user terminal 30 receives the selection of the live streaming from the viewer on the live streaming selection screen, it generates the streaming request including the stream ID of the selected live streaming and transmits to the server 10 via the network. The streaming info unit 302 may start to provide the live streaming, which is specified by the stream ID in the streaming request, to the user terminal 30. The streaming info unit 302 may update the stream DB 320 to add the viewer's viewer ID of the user terminal 30 to the streamer ID of the stream ID.

The relay unit 304 may relay the transmission of the live streaming from the user terminal 20 of the streamer to the user terminal 30 of the viewer in the live streaming started by the streaming info unit 302. The relay unit 304 may receive the signal, which indicates the user input from the viewer, from the input transmit unit 206 while the streaming data is reproducing. The signal indicating the user input may be the object-designated signal which indicates the designation of the object shown on the display of the user terminal 30. The object-designated signal may include the viewer ID of the viewer, the streamer ID of the streamer, who delivers the live streaming the viewer is viewing, and object ID specified by the object. If the object is a gift or the like, the object ID may be the gift ID or the like. Similarly, the relay unit 304 may receive the signal indicating the user input of the streamer, for example the object-designated signal, from the streaming unit 100 of the user terminal 20 while the streaming data is reproducing.

The monitoring unit 306 is configured to monitor the actions, behaviors, or operations the user of the user terminal performs in the platform. The user may perform operations on the platform, and the operations may be transmitted from the user terminal to the server 10 to realize the operation. In some embodiments, the operation may be any possible operations the user could perform on the platform. For example, the operation may be starting streaming, watching streaming, messaging, commenting, voting, billing, purchasing, gifting, gaming or the like.

The monitoring unit 306 may monitor the operations from the user terminal to check if the user encounters any problems or issues in the platform. For example, if the streamer tries to start the live streaming several times but fails, the monitoring unit 306 may detect that the streamer encountered issues when starting the streaming. In some embodiments, the monitoring unit 306 may monitor the operation by a look-up table 330, machine learning technology or the like.

The processing unit 308 is configured to process the subsequent procedure once problems or issues are detected by the monitoring unit 306. In some embodiments, the processing unit 308 may send a push notification to the user terminal of the user in response to detecting an issue by the monitoring unit 306. In some embodiments, the push notification may include the information on the issue. For example, the push notification may include a prompt asking the user if they have encountered any issues, what issues they have encountered, or to ask them to describe the issues they have encountered.

The information of the operation may include all possible information. For example, the information of operation may include user ID, event type, environmental parameters, user configurations, time information, location information, operation result or the like. The environmental parameters may be the information related to the user device such as device type, network strength, Wi-Fi stability or the like. The user configurations may be app version, service provider, feature toggles or the like.

Moreover, parameters related to specific operation may also be included. For example, if the user would like to pull or push a live streaming, the parameter may be network type (e.g., Wi-Fi, 4G, 5G), network provider (e.g., Chunghwa Telecom, Taiwan Mobile or the like), content delivery networks (e.g., Wangsu or the like) or the like. If the viewer would like to send a gift to the streamer, the parameter may be gift type, user region (e.g., Japan or Taiwan), user attributes (e.g., level, VIP status or the like) or the like. In some embodiments, parameters for sending gifts or other functions may be determined flexibly according to the APP or platform provider.

In some embodiments, the processing unit 308 may perform a checkup on the user terminal of the user for identifying the issue the user encountered. The checkup may be performed when the monitoring unit 306 detects that the user encounters a problem. The checkup may also be performed at the time point of receiving confirmation on the problem from the user.

This checkup may include a variety of measures such as network speed tests, latency checks or the like. For example, the processing unit 308 may check the device information of the terminal, network information, CPU usage, device temperature, service provider or the like. The network information may include, for example, the network connection (such as WIFI, 4G or 5G), the network speed, signal strength or the like. The service provider may be the company which provides the network service, streaming service, messaging service, gifting service, billing service or the like. According to the embodiments, the issue the user encountered may be identified in a more accurate manner.

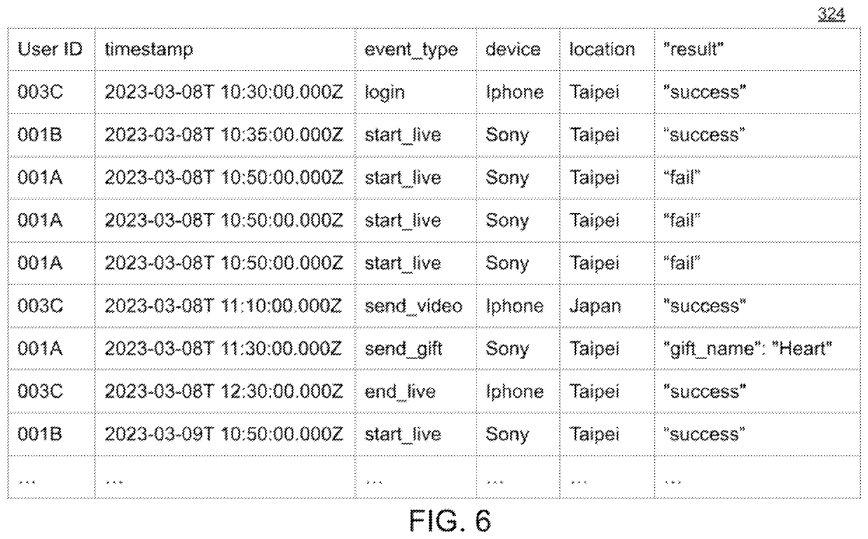

FIG. 4 shows an exemplary data structure of the stream DB 320 of FIG. 3. The stream DB 320 holds information regarding a live stream currently taking place. The stream DB 320 stores a stream ID for identifying a live-stream on a live distribution platform provided by the live-streaming system 1, a streamer ID for identifying the streamer who provides the live-stream, and a viewer ID for identifying a viewer of the live-stream, in association with each other.

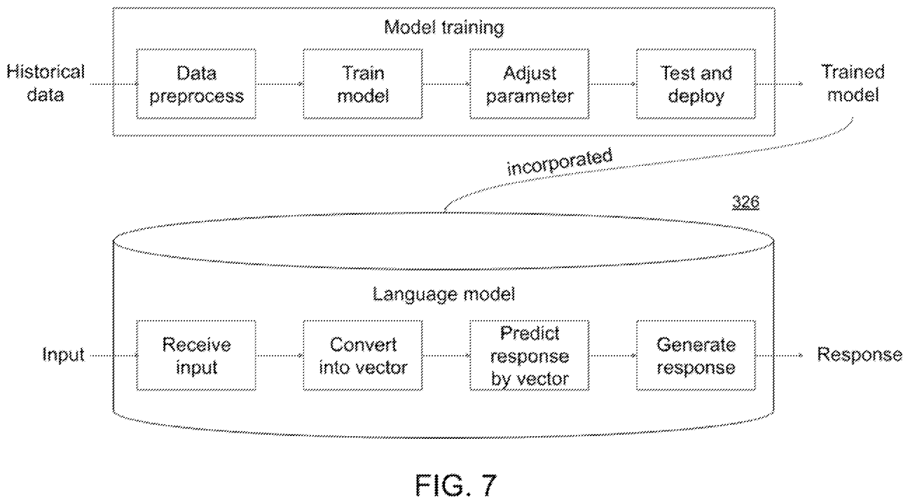

FIG. 5 shows an exemplary data structure of the user DB 322 of FIG. 3. The user DB 322 holds information regarding users. The user DB 322 stores a user ID for identifying a user, points that the user has, the level of the user, the status of the user, and the emotion score of the user, in association with each other.

The point is the electronic value circulated within the live-streaming platform. When a streamer receives a gift from a viewer during a live stream, the streamer's points increase by the value of the gift. The points are used, for example, to determine the amount of reward or money the streamer receives from the administrator of the live-streaming platform.

The level is an indicator of the amount of user activity or engagement on the live streaming platform. The level of the user is raised by giving gifts as a viewer, performing live streams as a distributor, participating in events, and the like. The server 10 calculates the level of the user from the history of the user's activity.

The status is an identity or membership status of the user on the live streaming platform. The status of the user may be obtained by purchasing, participating in events or the like. The server 10 may determine the status of the user from the purchase record of the user or the like.

The emotion score is an indication of the user's emotional state. In some embodiments, the emotion score may be generated by the language model 326 or the like. The language model 326 may take the operation of the user as an input and analyze whether the operation includes negative or positive emotion. For example, if the steamer fails streaming three times, the emotion score may be negative such as “−0.5” or the like. If the viewer comments that “the streaming room is laggy”, then the emotion score may also be negative such as “−0.1” or the like. In some embodiments, the mechanism of the emotion score may be designed flexibly according to the practical need.

In some embodiments, the emotion score may be a range of value indicating the negative, neutral or positive emotion of the user such as from −1 to 1. More specifically, the emotion score of the user may be −1 or 1 if they are in a negative or positive emotion. The emotion score may be calculated according to the operation they performed in the live streaming platform. In embodiments, the emotion score may also be calculated according to the look-up table 330 or machine learning technology or the like.

In some embodiments, the emotion score may be a range of value indicating specific emotion or personality such as happy or angry, impatient or patient or the like. The processing unit 308 may determine the type of customer service according to the emotion score. For example, the processing unit 308 may determine the online real-person customer service when the emotion score of the user is lower than a specific threshold or the like. In some embodiments, the emotion score and the corresponding customer service may be determined flexibly according to the practical need.

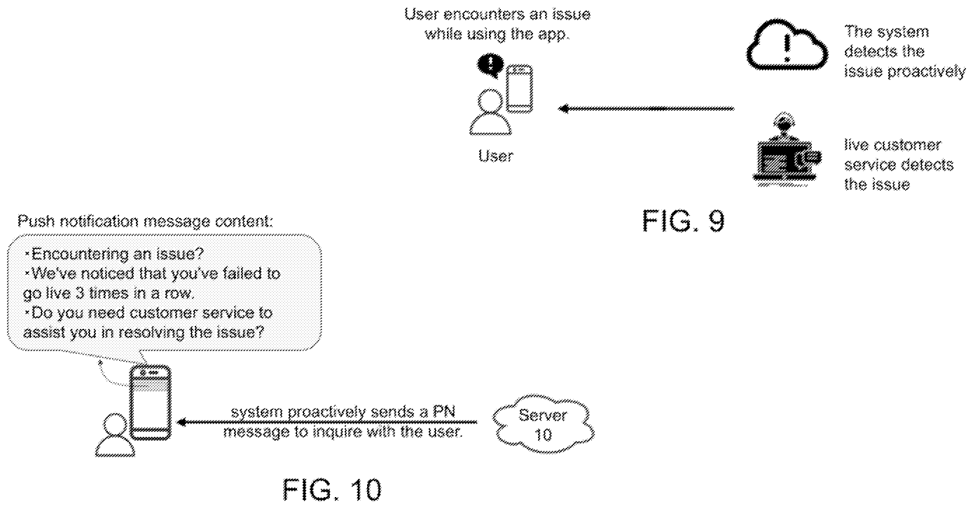

FIG. 6 shows an exemplary data structure of the log DB 324 of FIG. 3. The log DB 324 stores the operation data the user performed in the live streaming platform. The log DB 324 stores a user ID for identifying the user who performed the operation, the timestamp at which the user performed the operation, the event type identifying type of operation, the device identifying type of terminal the user uses, the location in which the user performed the operation, the result identifying the system response to the operation, in association with each other. In some embodiments, the log DB 324 may store any possible parameters for identifying the operation the user performed.

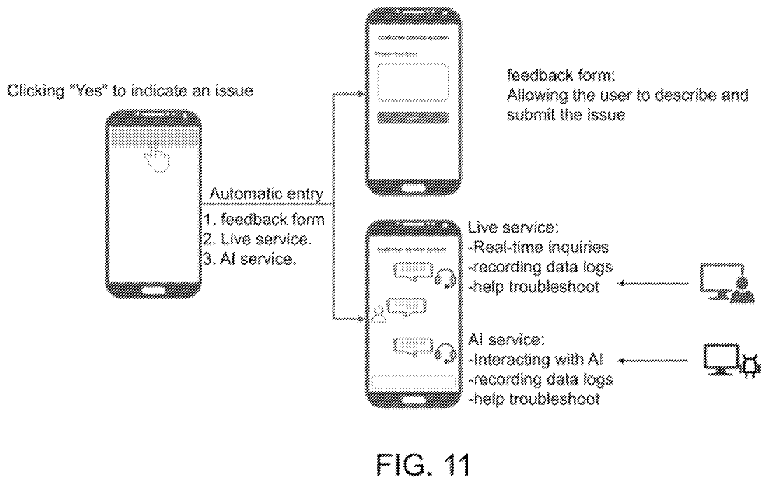

FIG. 7 shows an exemplary data structure of the language model 326 of FIG. 3. As shown in FIG. 7, the language model 326 may be trained using historical data via a process that includes data pre-processing, model training, parameter adjustment, and testing and deployment to generate a trained model. In embodiment, the historical data may be, for example, the historical operations the user performed in the live streaming platform, or the historical data from third party service providers or the like.

The trained model is then incorporated into the language model 326, which receives input and converts it into a vector, predicts a response based on the vector, and generates a response to be transmitted to the user. In some embodiments, the input may be the operations the user performed, the problem the user encounters, the response or feedback from the user or the like. In some embodiments, the input may also be message, video, audio, image, any data log or the like.

The language model 326 may be used for generating responses to a wide range of input and can be trained and adjusted to improve its accuracy and performance. The model can be deployed in various settings, including chatbots, virtual assistants, and other conversational interfaces. The language model 326 provides an effective and efficient solution for generating natural language responses in real-time interactions with users.

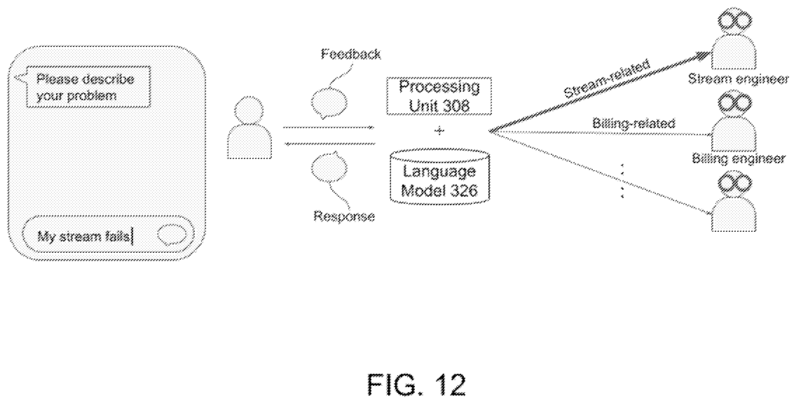

FIG. 8 shows an exemplary data structure of the look-up table 330 of FIG. 3. In some embodiments, the look-up table 330 may define the problems that users may encounter in the live streaming platform. For example, it may be defined that the streamer encountered problems on streaming if the streamer fails to start the live streamer three times. In some embodiments, these problems may be pre-defined, or trained and updated dynamically through machine learning technology or the like.

In some embodiments, look-up table 330 may also store the emotional value of the problem. The emotion value may be the value affecting the emotion score of the user, and there may be a corresponding value for each problem. For example, if the user fails on sending gifts over five times, the monitoring unit 306 may detect that the user encounters the problem and the processing unit 308 may update the emotion score in user DB 322 by adding the emotion value of “−0.1” on the emotion score of the user.

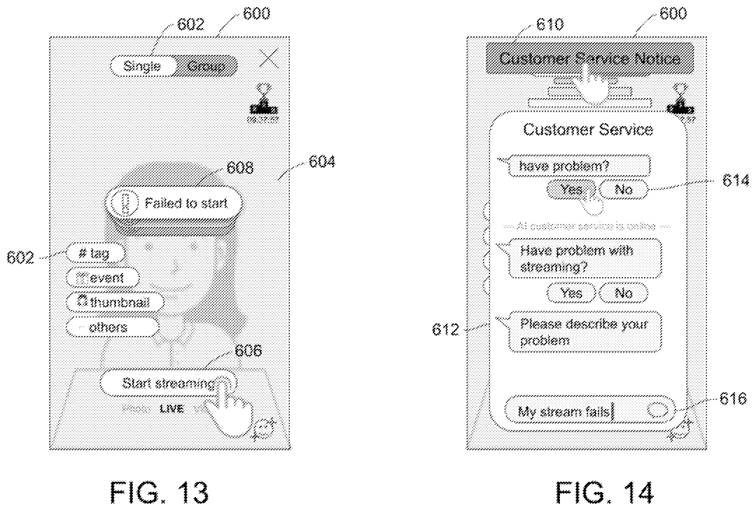

FIG. 9-FIG. 12 are exemplary functional configurations of the live streaming system 1 according to some embodiments of subject application.

As shown in FIG. 9 and FIG. 10, the user may encounter problems on streaming or gifting while using the user terminal to interact with the streamer via server 10. In some embodiments, the problem may be detected automatically by the server 10 or manually detected by the staff in the server 10. When the problem is detected by the server 10, a push notification message (PN) may be sent to the user terminal of the user. The push notification may include information related to the operation, the problem or the like. More specifically, the push notification may be the message to the user to inquire if they need assistance in resolving the problem. For example, the notification message may be “Encountering an issue?” or “We've noticed that you've failed to go live 3 times in a row.” or “Do you need customer service to assist you in resolving the issue?”

As shown in FIG. 11, the user may respond to the push notification by clicking the “Yes” or “No” button on the user terminal or the like. If the user clicks “No”, then no further action may be taken. On the other hand, if the user clicks “Yes” the user may be automatically directed to one of the customer services as shown in FIG. 11.

In some embodiments, the processing unit 308 may determine the type of customer service for the user according to information of the operation. As shown in FIG. 11, the customer service may include a feedback form, real-person live service, AI online customer service or the like.

The feedback form may allow the user to describe and submit the issue by themself, and the feedback would be handled by the staff in customer service. The real-person live service may allow the user to inquire with the customer service staff in real-time regarding the issue. The staff may check the environment parameters and data logs at the time and help the customer troubleshoot. The AI online customer service may allow the user to interact with an AI service. The AI service may record the environment parameters and data logs at the time and help the user troubleshoot or the like.

In some embodiments, the processing unit 308 may determine the type of customer service according to the emotion score, level, status or the like. For example, if the emotion score indicates that the user is in a negative emotion, the server 10 may direct the user to a real-person live customer service. In some embodiments, if the emotion score indicates that the user is in a neutral or positive emotion feeling positive or satisfied, the server 10 may offer the user AI online customer service, feedback form or the like.

In some embodiments, the processing unit 308 may further transmit the confirmed problem to a corresponding member for further analysis and resolution. In some embodiments, the processing unit 308 may use various techniques to detect the problem, such as monitoring system logs or analyzing user feedback. For example, the processing unit 308 may transmit the problem to the streaming engineer if the problem is streaming-related. In some embodiments, the function of connecting problems with related staff may be realized by tagging or labeling functions in machine learning technology or the like.

As shown in FIG. 12, the processing unit 308 may receive feedback from the user terminal of the user and input the feedback into the language model 326. The feedback may include the description or confirmation of the problem from the user or the like. The language model 326 may be the natural language model 326 trained by the server 10 itself or provided by a third-party service such as Google or the like. The language model 326 may also be an AI Chatbot such as ChatGPT or the like. The language model 326 may be used to, for example, summarize the issue, generating response according to the user feedback, identifying the problem or the like.

The language model 326 may process the feedback as input and generate an output according to the feedback. The processing unit 308 may further transmit the output to the user terminal of the user. In some embodiments, the output may be the response to the problems the user describes, and the processing unit 308 may transmit the response to the user for clarification and confirmation. In some embodiments, the communication between the user and server 10 may be more than once until the processing unit 308 receives the confirmation from the user terminal of the user.

In some embodiments, the processing unit 308 may receive information of the operation and the issue, and input the information into the language model 326. The information may include the information of operation the user performed, the issue detected by the monitoring unit 306 or the like.

The language model 326 may process the information as input and generate an output according to the information. The processing unit 308 may further transmit the output from the language model 326 to the user terminal of the user. In some embodiments, the output may be the summary of the issue and the processing unit 308 may transmit the summary to the user for confirmation. According to the summary mechanism that uses a language model 326, the server 10 may efficiently address user-reported issues and improve the user experience.

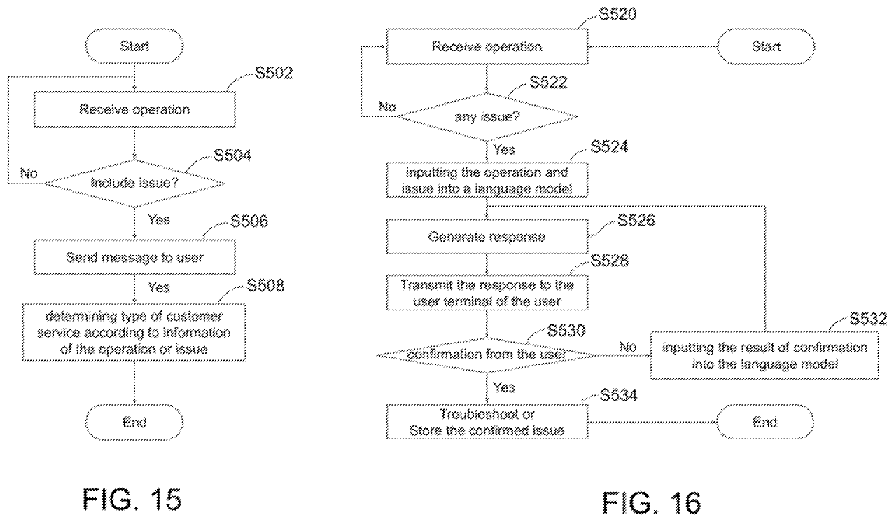

FIG. 13-FIG. 14 are exemplary screen images of a live streaming setting screen 600 shown on the display of the streamer user terminal 20.

As shown in FIG. 13, the live streaming setting screen 600 may include pre-setting button 602, streamer image 604, streaming button 606 and so on. The pre-setting button 602 may include all the pre-setting buttons for the live streaming such as setting tags, selecting events, changing thumbnail, setting filters or the like. The streamer image 604 may be obtained by reproducing the video data. The streaming button 606 may be the button to be clicked to start the live streaming.

The streamer may start the live streaming by clicking the streaming button 606. Once the streamer clicks the streaming button 606, a request to start a live streaming may be transmitted to the server 10. The processing unit 308 may store the request data log in a corresponding database such as log DB 324. If the streaming function fails to work, a message 608 would be displayed indicating that the streaming function fails or the like.

If the streamer fails to stream three times, three data logs of failing streaming may be transmitted to the server 10 and stored in the log DB 324. The monitoring unit 306 may detect that the streamer encounters a problem according to the data log of the operations. Once the monitoring unit 306 detects the problem, the processing unit 308 may send a push notification to the streamer.

As shown in FIG. 14, the streamer may receive a push notification 610. The streamer may click the push notification 610 to expand the full information 612. The full information 612 may include the information of the operation, problem or the like. In some embodiments, the full information 612 may also include a Yes/No button 614 for the user to easily confirm the issue. In some embodiments, when the user clicks “Yes” to indicate an issue, the user may automatically be directed to a customer service.

The full information 612 may also include a messaging tool 616 for the streamer to communicate with the server 10. The streamer may use the messaging tool 616 to provide feedback to the server 10, and the server 10 may input the feedback to the language model 326 and transmit the output to the streamer.

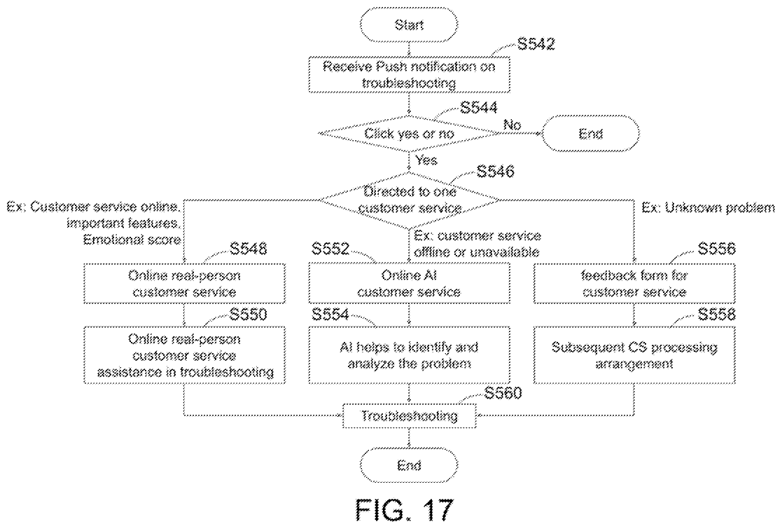

FIG. 15-FIG. 17 are flowcharts showing steps of an application activation process on live streaming system 1 according to some embodiments of subject application.

As shown in FIG. 15, when server 10 receives an operation from the user terminal of the user (S502), the monitoring unit 306 may check whether there is an issue associated with the operation (S504). If not (No in S504), the server 10 may continue to receive operations (S502). If the monitoring unit 306 detects an issue (Yes in S504), the processing unit 308 may send a message to the user (S506) to confirm or gather more information on the issue from the user. The processing unit 308 may further determine the type of customer service according to the information of the operation or issue (S508).

As shown in FIG. 16, when server 10 receives an operation from the user terminal of the user (S520), the monitoring unit 306 may check whether there is an issue associated with the operation (S522). If not (No in S522), the server 10 may continue to receive operations (S520). If the monitoring unit 306 detects an issue (Yes in S522), the processing unit 308 may input the operation and issue into a language model (S524). The language model may generate a response according to the input (S526).

The response may then be transmitted to the user terminal of the user (S528) and the server 10 may be pending for confirmation from the user (S530). If the user does not confirm the response, the processing unit 308 may further input the result of the confirmation into the language model (S532) to further refine the response generation process. If the user confirms the response, the processing unit 308 may perform the troubleshoot or store the confirmed issue for further process (S534). In some embodiments, the user may confirm the response by clicking the “yes” button or providing positive feedback. On the other hand, the user may deny the response by clicking the “no” button or providing negative feedback.

In some embodiments, the processing unit 308 may help the user troubleshoot or record the problem for further processing according to the problem. For example, if the problem is related to the connection between each node or entity, the processing unit 308 may direct the operation via another route. if the problem is related to the entity or node itself, the processing unit 308 may direct the operation to another node or entity. In some embodiments, if the problem is an unknown or time-consuming problem, the processing unit 308 may record the problem and provide the user some alternatives such as recommending the streamer with another interaction in the platform such as posting an article or the like.

In some embodiments, the processing unit 308 may identify a backup service for the operation. More specifically, the server 10 may include a plurality of services for realization of the operation. For each service, there may be one or more backup services when one of the services is unavailable, either due to technical failure or other reasons. For example, the viewer may send messages or gifts to the streamer via the server 10, and the server 10 may include more than one messaging or gifting service.

The messaging or gifting service may be realized by the server 10 itself or by a third-party service provider such as PubNub, Ably or the like. Once the monitoring unit 306 detects that the user has problem sending messages due to the outage of Ably, the processing unit 308 may identify another messaging service such as PubNub as backup service and forward the operation to the backup service. According to the embodiments, the problem from the user may be solved in an efficient manner, and the user experience may be improved.

In some embodiments, server 10 may include functions with different versions. For example, server 10 may include the current gifting function and previous gifting function. The current gifting function may be an updated version of the previous one. The user may download or access the current gifting function in the server 10 via network NW. In some embodiments, the current gifting function may include bugs that cause the user encountering problems. In some embodiments, server 10 may take the previous version of the gifting function as a backup service.

In some embodiments, the user may download or access the current gifting function while keeping the previous gifting function as a backup service. In some embodiments, the processing unit 308 may switch the current gifting function into the previous one when the user encounters a problem on the current gifting function. In some embodiments, the switching mechanism may be set automatically by the server 10 or user terminal, or manually by the user or the like.

For another example of troubleshooting, a streamer may initiate a live streaming request by sending a request to the server 10. The server 10 may respond by providing the streaming information, such as an URL in the streaming server, to the streamer terminal. The streamer then attempts to push the streaming data to the provided URL in the streaming server.

In the event of an error or no response from the streaming server, the streamer terminal of the streamer may report the issue to server 10. The server 10 may then troubleshoot the problem by, for example, sending streaming data to the streaming server for testing purposes. If server 10 identifies that the streaming server is experiencing an outage, server 10 may direct the streaming data from the streamer terminal to an alternative streaming service. This may be realized manually or automatically by changing the configuration of the streaming server for the user. Therefore, the streamer may start the live streaming in an efficient manner.

As shown in FIG. 17, the user may receive a push notification by the user terminal (S542). If the user clicked “no” (No in S544), no action may be taken and the process may end. If the user clicked “yes” to confirm the troubleshooting request (S544), the user may be directed to an appropriate customer service according to the information of the operation the user performed or the like (S546).

The processing unit 308 in server 10 may determine the type of customer service for the user according to a variety of parameters. For example, the processing unit 308 may direct the user to the online real-person customer service (S548) if the customer service is online or available. The processing unit 308 may direct the user to the online real-person customer service (S548) if the emotion score of the user is lower than a threshold. The processing unit 308 may direct the user to the online real-person customer service (S548) if the user encounters a problem on the important feature. Furthermore, the online real-person customer service may provide assistance in troubleshooting (S550).

The important feature may be the features that affect the use of the APP or platform, such as starting streaming or watching streaming. On the other hand, some additional features such as setting stickers or clicking “like” may not be referred to as an important feature. In some embodiments, the feature related to the revenue of the APP or platform may also be referred to as an important feature, such as gifting, event or the like. In some embodiments, the importance of the feature may be determined flexibly by the APP or platform provider.

In some embodiments, the processing unit 308 may determine the type of customer service according to time information. For example, the processing unit 308 may direct the user to the online real-person customer service if the operation is performed during the daytime or working time of the customer service or the like. In some embodiments, the processing unit 308 may direct the user to the online real-person customer service if the operation and problem is not defined in server 10, such as not being listed in the log DB 324 or the like.

The processing unit 308 may also provide customer service to users according to their point, level, status or the like. For example, the processing unit 308 may provide online real-person customer service if the user pays an amount of points. The processing unit 308 may provide online real-person customer service if the user is a Super VIP, with a level higher than a threshold or the like. In some embodiments, the customer service may be selectable for the user with specific point, level, status or the like.

The processing unit 308 described herein provides an efficient and cost-effective system for providing customer service to users. By providing different levels of customer service based on the user's point, level, or status, the processing unit 308 can improve customer satisfaction, loyalty, and retention. Additionally, the processing unit 308 can store information about the user's point, level, or status, as well as information about the customer service provided, to improve the quality of customer service in the future.

In some embodiments, if the customer service is offline or unavailable, the processing unit 308 may direct the user to the AI customer service (S552). The AI customer service may be equipped with a language model that helps identify and analyze the problem (S554). In some embodiments, the processing unit 308 may direct the user to the AI customer service if the operation and problem have been listed in server 10 before, such as being listed in the log DB 324, look-up table 330 or the like.

In some embodiments, if the problem is an unknown problem, the processing unit 308 may direct the user to a feedback form to collect feedback from the user (S556). The processing unit 308 may collect the feedback and perform subsequent customer service processing arrangements. After the appropriate customer service is identified, the processing unit 308 may perform the troubleshooting process (S560). According to the embodiment, the efficiency and accuracy of the troubleshooting process may be improved.

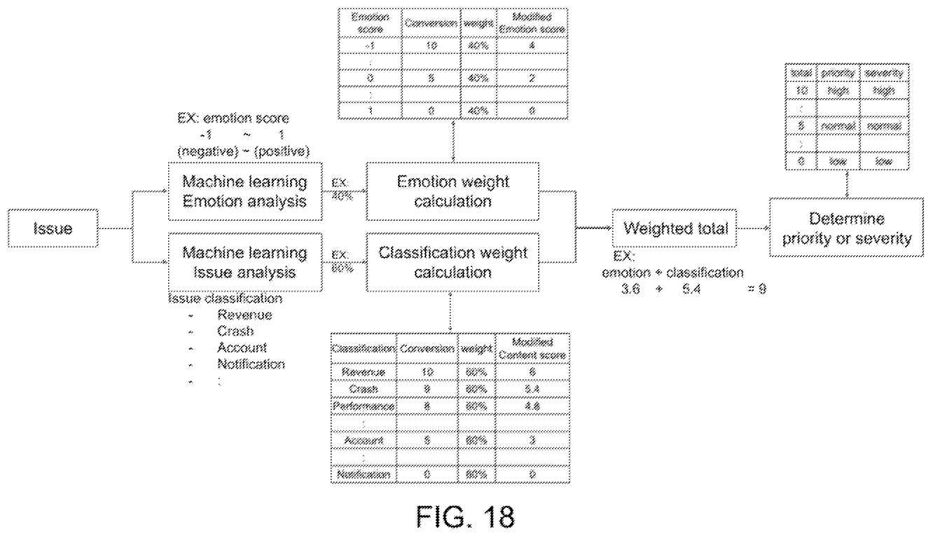

FIG. 18 is an exemplary functional configuration of the live streaming system 1 according to some embodiments of subject application. As shown in FIG. 18, once an issue is detected by the monitoring unit 306, the processing unit 308 may feed the information of the operation or the issue to the language model 326 to generate the emotion score by the machine learning technology or the like. The emotion score may then be converted and weighted to generate a modified emotion score. Similarly, the information of the issue may also be fed to the language model 326 to be analyzed and generate a classification score by machine learning technology. The classification score may then be converted and weighted to generate a modified classification score. The weight of emotion score and classification score may be adjusted flexibly according to practical need.

In some embodiments, the modified emotion score and modified classification score may then be used to calculate a weighted-total for the issue. This weighted-total represents the severity or priority of the issue. In particular, issues with higher weighted-totals may be considered more urgent and require immediate attention. The processing unit 308 may further determine the priority or severity of the issue according to the weighted-total. In some embodiments, the processing unit 308 may also determine the type of customer service according to the weighted-total score. For example, the weighted-total score of “0-3”, “3-7” or “7-10” may be assigned with feedback form, AI customer service or real-person customer service respectively. In some embodiments, the relationship between weighted-total score and corresponding customer service may be determined flexibly according to the practical need.

In some embodiments, the content of the issue may include different classifications such as revenue, crash, account, notification, performance, or the like. Each classification may have a corresponding score. For example, the revenue classification may correspond to “10”, while the notification classification may correspond to “0”. The weight of emotion score and classification score may be adjusted flexibly according to practical need. According to the embodiments, the issue the user encountered may be handled in an accurate and quick manner, and the efficiency and accuracy of issue management may be improved.

In some embodiments, the classification score may be an indication of the level of urgency of the issue. In some embodiments, the relationship between “issue classification” and “classification score” may be as follows: If the issue is urgent that it affects the normal use of the APP, the classification score may be higher. For example, issues related to live streaming and playback will correspond to a higher problem score. On the other hand, if the issue is related to additional features in the live stream, such as voting, liking, or mini games, the classification score may be relatively lower.

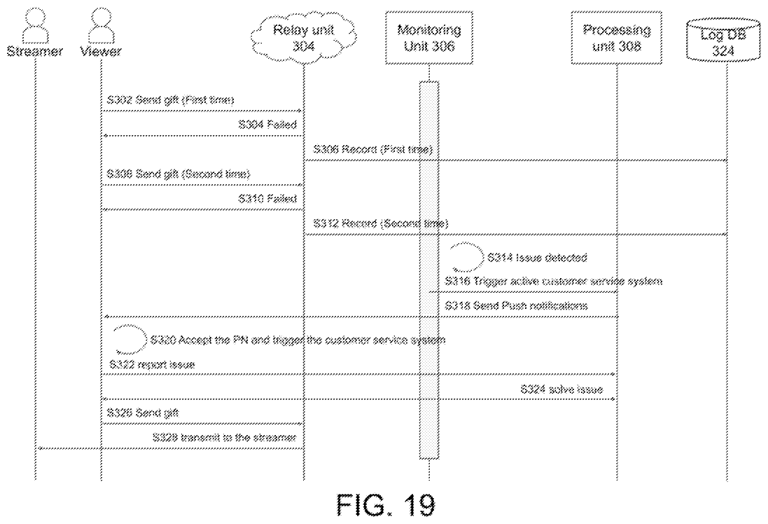

FIG. 19 is an exemplary sequence chart illustrating an operation of the configuration of the live streaming system 1 according to some embodiments of subject application. In FIG. 19, the viewer may send a gift to the streamer via relay unit 304 (S302). In some embodiments, the relay unit may return a response with a “failed” due to an outage or the like (S304). The relay unit 304 may further record the data log of the operation in the log DB 330 (S306). In some embodiments, the viewer may try to send the gift again (S308). If the operation fails again, the relay unit may return a response with a “failed” again (S310) and record the data log of the operation in the log DB 330 again (S312).

In some embodiments, if the monitoring unit 306 detects the “failure” of the operation from the user terminal (S314), the processing unit 308 may trigger the active customer service (S316). The processing unit 308 then sends a push notification to the viewer (S318). The viewer may confirm or deny the push notification (S320). If the user confirms the push notification, then the customer service may be triggered. The viewer may feedback the issue (S322) and the processing unit 308 may then attempt troubleshooting for the viewer (S324). If the issue is resolved, the viewer may send the gift (S326) and the relay unit 304 may transmit the data of the gift to the user terminal of the streamer (S328).

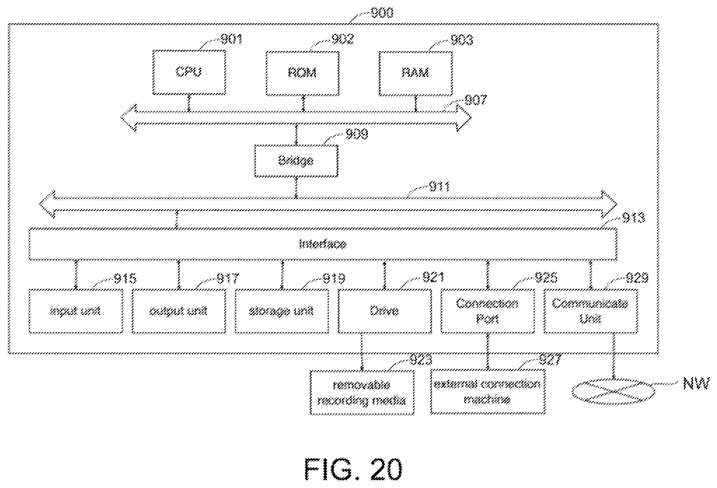

FIG. 20 is a schematic block diagram of computer hardware for carrying out a system configuration and processing according to some embodiments of subject application. The information processing device 900 in FIG. 20 is, for example, is configured to realize the server 10 and the user terminal 20, 30 respectively according to some embodiments of subject application.

The information processing device 900 includes a CPU 901, read only memory (ROM) 903, and random-access memory (RAM) 905. In addition, the information processing device 900 may include a host bus 907, a bridge 909, an external bus 911, an interface 913, an input unit 915, an output unit 917, a storage unit 919, a drive 921, a connection port 925, and a communication unit 929. The information processing device 900 may include imaging devices (not shown) such as cameras or the like. The information processing device 900 may include a processing circuit such as a digital signal processor (DSP) or an application-specific integrated circuit (ASIC), instead of or in addition to the CPU 901.

The CPU 901 functions as an arithmetic processing device and a control device, and controls the overall operation or a part of the operation of the information processing device 900 according to various programs recorded in the ROM 903, the RAM 905, the storage unit 919, or a removable recording medium 923. For example, the CPU 901 controls overall operations of respective function units included in the server 10 and the user terminal 20 and 30 of the above-described embodiment. The ROM 903 stores programs, operation parameters, and the like used by the CPU 901. The RAM 905 transiently stores programs used when the CPU 901 is executed, and parameters that change as appropriate when executing such programs. The CPU 901, the ROM 903, and the RAM 905 are connected with each other via the host bus 907 configured from an internal bus such as a CPU bus or the like. The host bus 907 is connected to the external bus 911 such as a Peripheral Component Interconnect/Interface (PCI) bus via the bridge 909.

The input unit 915 is a device operated by a user such as a mouse, a keyboard, a touchscreen, a button, a switch, and a lever. The input unit 915 may be a device that converts physical quantity to electrical signal such as audio sensor (such as microphone or the like), acceleration sensor, tilt sensor, infrared radiation sensor, depth sensor, temperature sensor, humidity sensor or the like. The input unit 915 may be a remote-control device that uses, for example, infrared radiation and another type of radio waves. Alternatively, the input unit 915 may be an external connection device 927 such as a mobile phone that corresponds to an operation of the information processing device 900. The input unit 915 includes an input control circuit that generates input signals on the basis of information which is input by a user to output the generated input signals to the CPU 901. The user inputs various types of data and indicates a processing operation to the information processing device 900 by operating the input unit 915.

The output unit 917 includes a device that can visually or audibly report acquired information to a user. The output unit 917 may be, for example, a display device such as an LCD, a PDP, and an OLED, an audio output device such as a speaker and a headphone, and a printer. The output unit 917 outputs a result obtained through a process performed by the information processing device 900, in the form of text or video such as an image, or sounds such as audio sounds.

The storage unit 919 is a device for data storage that is an example of a storage unit of the information processing device 900. The storage unit 919 includes, for example, a magnetic storage device such as a hard disk drive (HDD), a semiconductor storage device, an optical storage device, or a magneto-optical storage device. The storage unit 919 stores therein the programs and various data executed by the CPU 901, and various data acquired from an outside.

The drive 921 is a reader/writer for the removable recording medium 923 such as a magnetic disk, an optical disc, a magneto-optical disk, and a semiconductor memory, and built in or externally attached to the information processing device 900. The drive 921 reads out information recorded on the mounted removable recording medium 923, and outputs the information to the RAM 905. The drive 921 writes the record into the mounted removable recording medium 923.

The connection port 925 is a port used to directly connect devices to the information processing device 900. The connection port 925 may be a Universal Serial Bus (USB) port, an IEEE1394 port, or a Small Computer System Interface (SCSI) port, for example. The connection port 925 may also be an RS-232C port, an optical audio terminal, a High-Definition Multimedia Interface (HDMI (registered trademark)) port, and so on. The connection of the external connection device 927 to the connection port 925 makes it possible to exchange various kinds of data between the information processing device 900 and the external connection device 927.

The communication unit 929 is a communication interface including, for example, a communication device for connection to a communication network NW. The communication unit 929 may be, for example, a wired or wireless local area network (LAN), Bluetooth (registered trademark), or a communication card for a wireless USB (WUSB).

The communication unit 929 may also be, for example, a router for optical communication, a router for asymmetric digital subscriber line (ADSL), or a modem for various types of communication. For example, the communication unit 929 transmits and receives signals on the Internet or transmits signals to and receives signals from another communication device by using a predetermined protocol such as TCP/IP. The communication network NW to which the communication unit 929 connects is a network established through wired or wireless connection. The communication network NW is, for example, the Internet, a home LAN, infrared communication, radio wave communication, or satellite communication.

The imaging device (not shown) is a device that images real space using an imaging device such as a charge coupled device (CCD) or a complementary metal oxide semiconductor (CMOS), for example, and various members such as a lens for controlling image formation of a subject image on the imaging device and generates a captured image. The imaging device may capture a still picture or may capture a movie.

The present disclosure of the live streaming system 1 has been described with reference to embodiments. The above-described embodiments have been described merely for illustrative purposes. Rather, it can be readily conceived by those skilled in the art that various modifications may be made in making various combinations of the above-described components or processes of the embodiments, which are also encompassed in the technical scope of the present disclosure.

The procedures described herein, particularly flowchart or those described with a flowchart, are susceptible of omission of part of the steps constituting the procedure, adding steps not explicitly included in the steps constituting the procedure, and/or reordering the steps. The procedure subjected to such omission, addition, or reordering is also included in the scope of the present disclosure unless diverged from the purport of the present disclosure.

In some embodiments, at least a part of the functions performed by the server 10 may be performed by other than the server 10, for example, being performed by the user terminal 20 or 30. In some embodiments, at least a part of the functions performed by the user terminal 20 or 30 may be performed by other than the user terminal 20 or 30, for example, being performed by the server 10. In some embodiments, the rendering of the frame image may be performed by the user terminal of the viewer, the server, the user terminal of the streamer or the like.

Furthermore, the system and method described in the above embodiments may be provided with a computer-readable non-transitory storage device such as a solid-state memory device, an optical disk storage device, or a magnetic disk storage device, or a computer program product or the like. Alternatively, the programs may be downloaded from a server via the Internet.

Although technical content and features of the present disclosure are described above, a person having common knowledge in the technical field of the present disclosure may still make many variations and modifications without disobeying the teaching and disclosure of the present disclosure. Therefore, the scope of the present disclosure is not limited to the embodiments that are already disclosed but includes another variation and modification that do not disobey the present disclosure, and is the scope covered by the following patent application scope.

LIST OF REFERENCE NUMBERS

| | | | |
|---|---|---|---|
| 1 | Live streaming system | 10 | Server |
| 20 | User terminal | 100 | Streaming unit |
| 102 | Video control unit | 104 | Audio control unit |
| 106 | Distribution unit | 108 | UI control unit |
| 200 | Viewing unit | 202 | UI control unit |
| 204 | Rendering unit | 206 | Input unit |
| 30, 30a, | User terminal | 302 | Providing unit |
| 30b | | | |
| 304 | Relay unit | 320 | Stream DB |
| 322 | User DB | 324 | Log DB |
| 326 | Language model | 330 | look-up table |
| 600 | screen | 602 | pre-setting button |
| 604 | streamer image | 606 | streaming button |
| 608 | message | 610 | push notification |
| 612 | information | 614 | button |
| 616 | messaging tool | | |
| 900 | Information processing | 901 | CPU |
| | device | | |
| 903 | ROM | 905 | RAM |
| 907 | Host bus | 909 | Bridge |
| 911 | External bus | 913 | Interface |
| 915 | Input unit | 917 | Output unit |
| 919 | Storage unit | 921 | Drive |
| 923 | Removable recording | 925 | Connection port |
| | medium | | |
| 927 | External connection | 929 | Communication unit |
| | device | | |
| LS | Live streaming | LV | Streamer |
| NW | Network | SP | Specific portion |
| | | AUI, AU2 | Viewer |
| | | VD, | Video |
| | | VD1, VD2 | |

What is claimed is:

1. A server for handling operations in a live streaming platform, comprising one or a plurality of processors, wherein the one or plurality of processors execute a machine-readable instruction to perform:
receiving an operation from a user terminal of a user;
sending a message to the user terminal of the user in response to detecting an issue from the operation; and
determining type of customer service according to information of the operation and the issue.

2. The server according to claim 1, further comprising:
providing customer service of the determined type to the user terminal of the user in response to receive confirmation regarding the message; wherein
the operation is related to interactions between the user and other users in the live streaming platform.

3. The server according to claim 1, further comprising:
inputting the information of the operation and the issue into a language model;
generating a summary of the issue from the language model; and
transmitting the summary to the user terminal of the user.

4. The server according to claim 3, further comprising:
receiving feedback on the summary from the user of the user terminal;
inputting the feedback into the language model; and
transmitting an output from the language mode to the user terminal of the user.

5. The server according to claim 1, further comprising:
generating an emotion score and/or a classification score from a language model; and
further determining the type of customer service according to the emotion score and/or the classification score; wherein
the emotion score is an indication of the user's emotional state; and
the classification score is an indication of the level of urgency of the issue.

6. The server according to claim 1, further comprising:
receiving user attribute of the user; and
further determining the type of customer service according to the user attribute; wherein
the user attribute includes the point, level or status of the user in the live streaming platform.

7. The server according to claim 1, further comprising:
identifying a backup service for the operation; and
forwarding the operation to the backup service; wherein
the backup service is a previous version of a current function, a third-party service, or a service in the server for the current function.

8. The server according to claim 1, further comprising:
performing a checkup on the user terminal of the user at the time point of receiving confirmation from the user; wherein
the checkup includes measures related to the operation and the issue.

9. A method for handling operations in a live streaming platform, comprising:
receiving an operation from a user terminal of a user;
sending a message to the user terminal of the user in response to detecting an issue from the operation; and
determining type of customer service according to information of the operation and the issue.

10. A non-transitory computer-readable medium including program instructions, that when executed by one or more processors, cause the one or more processors to execute:
receiving an operation from a user terminal of a user;
sending a message to the user terminal of the user in response to detecting an issue from the operation; and
determining type of customer service according to information of the operation and the issue.
